(19) United States
(12) Patent Application Publication
(10) Pub. No.: US 2025/0189310 A1
(43) Pub. Date: Jun. 12, 2025

(54) Sensor Apparatus

(71) Applicant: Sumitomo Precision Products Co., Ltd., Amagasaki-shi, Hyogo (JP)

(72) Inventors: Hideyuki DOYAMA, Amagasaki-shi, Hyogo (JP); Ryohei UCHINO, Amagasaki-shi, Hyogo (JP)

(21) Appl. No.: 18/845,577

(22) PCT Filed: Mar. 20, 2023
(86) PCT No.: PCT/JP2023/010888

§ 371 Date: Sep. 10, 2024

(30) Foreign Application Priority Data
Mar. 28, 2022 (JP) 2022-052556

(51) Int. Cl. G01C 19/5783; G01D 11/24

(52) U.S. Cl. CPC G01C 19/5783; G01D 11/24

(57) ABSTRACT

A sensor apparatus (100) according to this invention includes a plurality of sensors (2) for detecting physical quantities; a sensor arrangement part (1) including a plurality of recessed parts (11) that are opened in different directions from each other and in which the plurality of sensors (2) are arranged; shielding lids (7) for shielding against electromagnetic noise arranged between the recessed parts (11) and the shielding cover (4) and covering the plurality of recessed parts (11) to prevent exposure of the plurality of sensors (2) that are arranged in the plurality of recessed parts (11).

### TECHNICAL FIELD

The present invention relates to a sensor apparatus, and particularly to a sensor apparatus including a sensor arrangement part to which a plurality of sensors are provided.

### BACKGROUND ART

Sensor apparatuses including a sensor arrangement part to which a plurality of sensors are provided are known in the art. Such a sensor apparatus is disclosed in Japanese Patent Laid-Open Publication No. JP 2021-67625, for example.

The inertial measurement device (sensor apparatus) described in Japanese Patent Laid-Open Publication No. JP 2021-67625 includes a printed circuit board (sensor arrangement part) to which a plurality of gyroscopes corresponding to X, Y and Z axes are provided. Also, the aforementioned inertial measurement device includes a case provided to cover the plurality of gyroscopes. In other words, the plurality of gyroscopes are accommodated in accommodation space defined by the printed circuit board and the case. The plurality of gyroscopes are arranged in the aforementioned accommodation space to be exposed from the accommodation space (in an uncovered state).

### PRIOR ART

### Patent Document

Patent Document 1: Japanese Patent Laid-Open Publication No. JP 2021-67625

### SUMMARY OF THE INVENTION

### Problems to be Solved by the Invention

In a case in which a plurality of gyroscopes (the same type of sensors) are arranged in a case as disclosed in Japanese Patent Laid-Open Publication No. JP 2021-67625, the plurality of gyroscopes are necessarily arranged at different positions and in different orientations in the case so as to correspond to the X, Y and Z axes. However, in the case in which the plurality of gyroscopes are arranged in the case to be exposed from the case as in disclosed in Japanese Patent Laid-Open Publication No. JP 2021-67625, an exterior surface of one of the sensors is close to and an exterior surface of another of the sensors is away from interior surfaces of components that form the case so that positions of exterior surfaces of the sensors, and distances between the exterior surfaces of the sensors and the interior surfaces of components become different depending on which sensor each exterior surface belongs. For this reason, influence of noise that enters the case becomes different depending on which sensor the influence affects.

The present invention is intended to solve the above problem, and one object of the present invention is to provide a sensor apparatus capable of reducing difference of influence of noise between a plurality of sensors in a case in which the plurality of sensors for detecting the same type of physical quantities are provided.

### Means for Solving the Problems

In order to attain the aforementioned object, a sensor apparatus according to an aspect of the present invention includes a plurality of sensors for detecting a common type of physical quantities acting in two or more directions different from each other; a sensor arrangement part including a plurality of recessed parts that are opened in different directions from each other and in which the plurality of sensors are arranged; a shielding cover for shielding against electromagnetic noise, the shielding cover being arranged to cover the sensor arrangement part and including at least one first opening; and shielding lids for shielding against the electromagnetic noise, the shielding lids being arranged between the plurality of recessed parts and the shielding cover and covering the plurality of recessed parts to prevent exposure of the plurality of sensors that are arranged in the plurality of recessed parts.

In the sensor apparatus according to the aspect of the present invention, as discussed above, a shielding lid for shielding against electromagnetic noise is provided to be arranged between the recessed part included in the sensor arrangement part and the shielding cover covering the sensor arrangement part, and to cover the recessed part to prevent exposure of the sensor that is arranged in the recessed part. Accordingly, the shielding lid can provide electromagnetic noise shielding even if electromagnetic noise enters an interior of the shielding cover. In other words, electromagnetic noise shielding can be duplicately provided by the shielding cover and the shielding lid. In particular, in a case in which the recessed parts are formed by cutting-out machining, the sensors will be covered by the recessed parts without any gaps except opened sides of the recessed parts for the sensors. As a result, even if the plurality of sensors are arranged in a case, and the plurality of sensors are arranged in different positions and orientations in the sensor arrangement part, electromagnetic noise shielding can be duplicately provided by the shielding cover and the shielding lid. Consequently, it is possible to reduce difference of influence of noise between the plurality of sensors in a case in which the plurality of sensors for detecting the same type of physical quantities are arranged in positions and orientations different from each other.

In the sensor apparatus according to the aforementioned aspect, it is preferable that a controller for receiving information from the plurality of sensors is further provided; that at least one of the plurality of sensors includes a sensor main body, and a connection wiring part between the sensor main body and the controller; and that at least one of the plurality of recessed parts of the sensor arrangement part and/or at least one of the plurality of shielding lids includes a second opening through which the connection wiring part is drawn out. According to this configuration, even in a case in which the recessed part is covered by the shielding lid, the connection wiring part can be easily drawn out from the recessed part through the second opening.

In this configuration, it is preferable that the connection wiring part of the sensor includes a flexible cable. According to this configuration, since the connection wiring part can be drawn out from the recessed part while being bent, it is possible to easily draw the connection wiring part out of the recessed part.

In the sensor apparatus according to the aforementioned aspect, it is preferable that a base for shielding against the electromagnetic noise is provided to be fixed to the sensor arrangement part and to be arranged to close the first opening of the shielding cover and to cover at least one of the plurality of recessed parts. According to this configuration, since the base, which is fixed to the sensor arrangement member, also serves as a part for shielding the sensor from electromagnetic noise, it is possible to prevent a configuration of the sensor apparatus from becoming complicated while reducing the number of parts.

In this configuration, it is preferable that a projected area of the base as viewed in a direction perpendicular to surfaces of the base and the shielding cover that face each other is larger than an opening area of the first opening of the shielding cover. According to this configuration, since the first opening of the shielding cover is entirely covered by the base, it is possible to effectively reduce electromagnetic noise entering the shielding cover.

In the sensor apparatus according to the aforementioned aspect, it is preferable that all of the plurality of sensors that are arranged in the plurality of recessed parts of the sensor arrangement part and measure the common type of physical quantities are identical to each other in design. According to this configuration, since correction control of the sensor apparatus for correcting difference between the sensors due to difference of sensor designs can be eliminated, such elimination together with advantages of the present invention including reduction of influences of electromagnetic noise from the outside of the sensor apparatus and reduction of evenness of noise entering the sensors allows easy correction control of the sensor apparatus.

In this configuration, it is preferable that the plurality of sensors include one sensor set of a first-axis sensor, a second-axis sensor and a third-axis sensor corresponding a first axis, a second axis and a third axis perpendicular to each other or a plurality of sensor sets of first-axis sensors, second-axis sensors and third-axis sensors corresponding the first axis, the second axis and the third axis perpendicular to each other; and that the sensor arrangement part includes a first surface that extends perpendicular to the first axis and includes the recessed part in which the first axis sensor is arranged, a second surface that extends perpendicular to the second axis and includes the recessed part in which the second axis sensor is arranged, and a third surface that extends perpendicular to the third axis and includes the recessed part in which the third axis sensor is arranged. According to this configuration, it is possible to reduce difference between influences of noise on the first axis sensor, the second axis sensor, and the third axis sensor.

In the sensor apparatus in which at least one set of the first axis sensor, the second sensor and the third axis sensor are provided, it is preferable that the plurality of sensors include the plurality of sensor sets of the first-axis sensors, the second-axis sensors and the third-axis sensors. According to this configuration, it is possible to reduce difference between influences of noise on the first axis sensor, the second axis sensor, and the third axis sensor even in a case in which a plurality of sets of sensors are included.

In this configuration, it is preferable that two or more of the plurality of recessed parts of the sensor arrangement part in which the first axis sensors are arranged have a common shape; two or more of the plurality of recessed parts of the sensor arrangement part in which the second axis sensors are arranged have a common shape; and two or more of the plurality of recessed parts of the sensor arrangement part in which the third axis sensors are arranged have a common shape. According to this configuration, since two or more of the plurality of recessed parts have the common shape, it is possible to simplify production of the sensor arrangement part as compared with a case in which the two or more of the plurality of recessed parts have shapes different from each other. Also, the two or more of the plurality of recessed parts for a plurality of the first-axis sensors (a plurality of the second-axis sensors, a plurality of the third-axis sensors) have the common shape, distances between interior surfaces of the recessed parts and exterior surfaces of the sensors can be the same in the plurality of the first-axis sensors (the plurality of the second-axis sensors, the plurality of the third-axis sensors), and as a result, it is possible to reduce noise influence difference between the plurality of the first-axis sensors (between the plurality of the second-axis sensors, between the plurality of the third-axis sensors).

In the sensor apparatus in which two or more of the plurality of recessed parts have the common shape, it is preferable that the sensor arrangement part has a rectangular parallelepiped shape. According to this configuration, it is possible to easily arrange the first axis sensor, the second axis sensor and the third axis sensor to correspond to the first axis, the second axis and the third axis, respectively, which are perpendicular to each other.

In the sensor apparatus according to the aforementioned aspect, it is preferable that each of the sensors includes a gyroscope. Here, the gyroscopes process very small signals, and are susceptible to electromagnetic noise. For this reason, electromagnetic noise shielding provided by the shielding lid is particularly effective at properly operating the gyroscopes.

In the sensor apparatus according to the aforementioned aspect, it is preferable that the shielding lid has a plate-like shape extending along a surface of the sensor arrangement part. According to this configuration, since a protrusion height of the shielding lid from the sensor arrangement part can be small, it is possible to reduce size of the sensor apparatus as compared with a case in which the shielding lid has a box shape, for example.

In the sensor apparatus according to the aforementioned aspect, it is preferable that the shielding lid includes a non-magnetic material. According to this configuration, since electromagnetic noise shielding can be more reliably provided by the shielding lid, it is possible to more reliably prevent anomalies caused by electromagnetic noise in the sensors covered by the shielding lid.

### Effect of the Invention

According to the present invention, as discussed above, it is possible to reduce difference of influence of noise between the plurality of sensors in a case in which the plurality of sensors for detecting the same type of physical quantities are provided.

### BRIEF DESCRIPTION OF THE DRAWINGS

FIG. 1 is an exploded perspective view entirely showing a sensor apparatus according to one embodiment.

FIG. 2 is an exploded perspective view showing a sensor mount, and control and power supply boards according to the one embodiment.

FIG. 3 is an exploded perspective view showing the sensor mount, gyroscopes, and plates according to the one embodiment.

FIG. 4 is a perspective view of the sensor mount according to the one embodiment as diagonally viewed from a lower side.

FIG. 5 is a block diagram showing a configuration of a sensor apparatus according to the one embodiment.

FIG. 6 is a schematic sectional view showing a relation between a connection wiring part and a cut-out part in the one embodiment.

FIG. 7 is a perspective view showing a configuration of the gyroscope according to the one embodiment.

### MODES FOR CARRYING OUT THE INVENTION

Embodiments according to the present invention will be described with reference to the drawings.

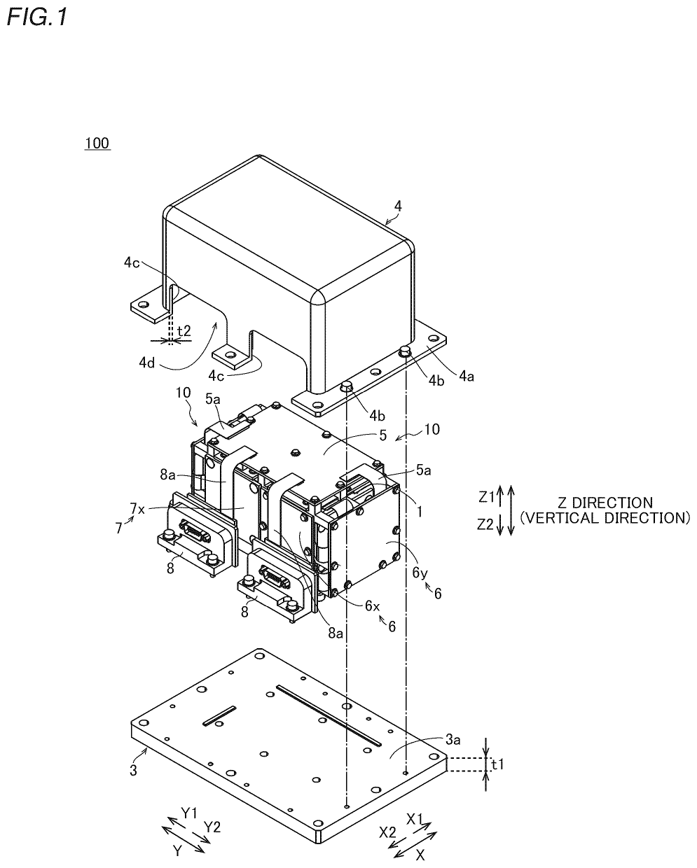

A sensor apparatus 100 according to one embodiment is first described with reference to FIGS. 1 to 7.

### Entire Configuration of Sensor Apparatus

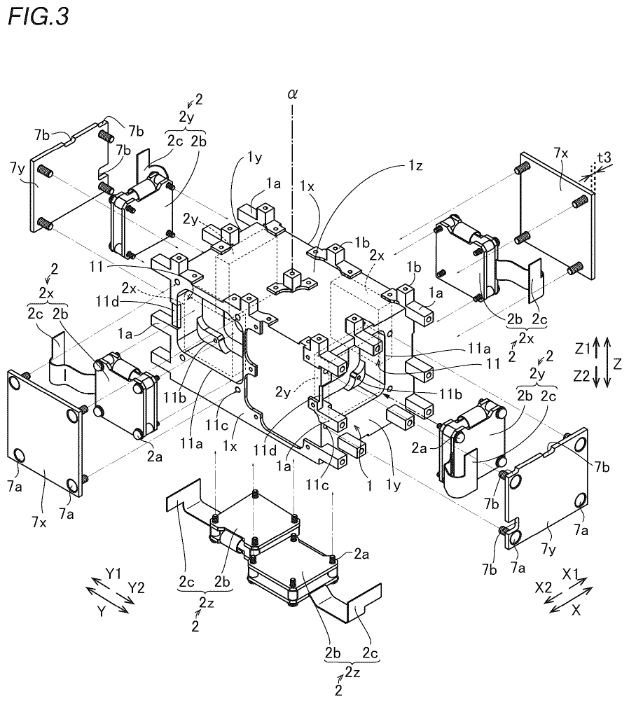

As shown in FIG. 1, the sensor apparatus 100 includes a sensor mount 1, gyroscopes 2 (see FIG. 3), a base 3, a cover 4, a power supply board 5, control boards 6 and plates 7. Here, the sensor mount 1 and the gyroscope 2 are an example of a “sensor arrangement part” and an example of a “sensor”, respectively, in the claims. Also, the cover 4 and the plates 7 are an example of a “shielding cover” and examples of a “shielding lid”, respectively, in the claims. Also, the control boards 6 are examples of a “controller” in the claims.

Two connectors 8 for connecting to the power supply board 5 to an external power supply (not shown) and for transmitting/receiving signals are attached to the sensor mount 1. The connectors 8 are connected to the power supply board 5 through flexible cables 8a. The flexible cables 8a are provided to the sensor apparatus 100 with being bent. Any of FPC (Flexible printed Circuit) and FFC (Flexible Flat Cable) can be used as the flexible cables 8a.

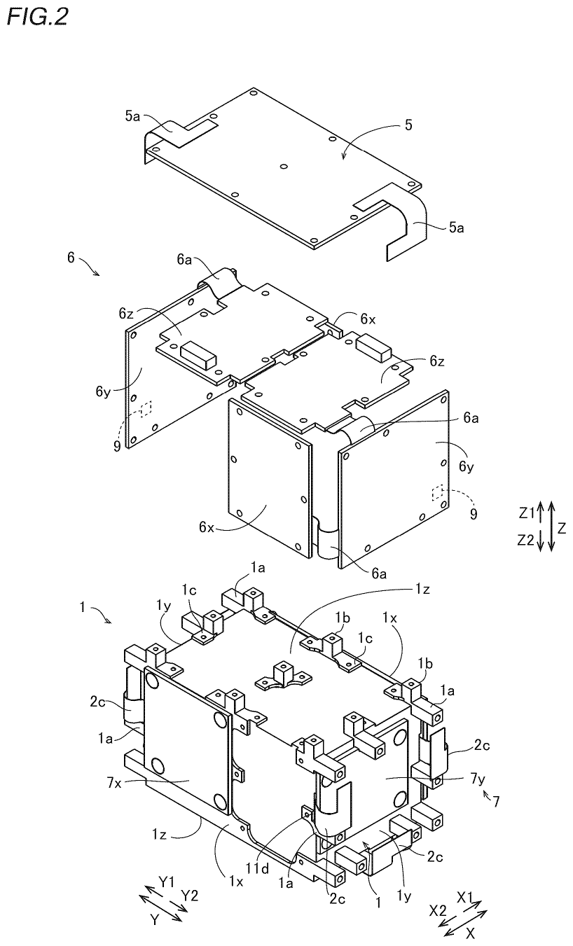

The sensor mount 1 has a rectangular parallelepiped shape, as shown in FIG. 2. Also, the sensor mount 1 includes a pair of X-axis surfaces 1x, which extend perpendicular to an X axis, a pair of Y-axis surfaces 1y, which extend perpendicular to a Y axis, and a pair of Z-axis surfaces 1z, which extend perpendicular to a Z axis. Here, the X-axis surfaces 1x are examples of a “first surface” and a “surface of the sensor arrangement part” in the claims. Also, the Y-axis surfaces 1y are examples of a “second surface” and the “surface of the sensor arrangement part” in the claims. Also, the Z-axis surface 1z on a Z2 side of the pair of Z-axis surfaces 1z is an example of a “third surface” in the claims. Also, the X-axis is an example of a “first axis” in the claims. Also, the Y-axis is an example of a “second axis” in the claims. Also, the Z-axis is an example of a “third axis” in the claims. Here, in this embodiment, the Z axis is an axis that extends in a vertical direction.

The sensor mount 1 includes a plurality of Y-axis protrusions 1a which are arranged on each of the pair of Y-axis surfaces 1y to protrude from the Y-axis surfaces 1y. The Y axis control boards 6y described later are connected (fastened) to the Y-axis protrusions 1a.

Also, the sensor mount 1 includes a plurality of Z-axis protrusions 1b which are arranged on the Z-axis surface 1z on the Z1 side to protrude from the Z-axis surface 1z. The power supply board 5 is connected (fastened) to the Z-axis protrusions 1b. Also, the sensor mount 1 includes a plurality of Z-axis protrusions 1c which are arranged on the Z-axis surface 1z on the Z1 side to protrude from the Z-axis surface 1z. A protrusion amount of the Z-axis protrusions 1c is smaller than a protrusion amount of the Z-axis protrusions 1b. The Z-axis control boards 6z described later are connected (fastened) to the Z-axis protrusions 1c.

The sensor mount 1 is also formed of metal. Specifically, the sensor mount 1 is formed of a non-magnetic metal (e.g., aluminum alloy). In other words, the sensor mount 1 provides electromagnetic (magnetic flux) shielding. Also, the sensor mount 1 is fixed to the base 3 by screws and the like (not shown) for fastening the sensor mount to the base 3.

The cover 4 is arranged to cover the sensor mount 1, and has at least one opening 4d, as shown in FIG. 1. Specifically, the cover 4 has a box shape for accommodating the sensor mount 1. The cover 4 is opened on its Z2 side. Specifically, the sensor mount 1 is accommodated in accommodation space defined by the cover 4 and the base 3. In other words, the cover 4, the base 3 and the connectors 8 cover the sensor mount 1 so that the sensor mount 1 is not exposed. The opening 4d is an example of a “first opening” in the claims. Here, the sensor mount 1 may be covered by the cover 4 without the cut-out parts 4c, which will be described later, and the base 3 so that the sensor mount 1 is not exposed.

The cover 4 is formed of metal. Specifically, the cover 4 is formed of a non-magnetic metal (e.g., aluminum alloy).

In other words, the cover 4 provides electromagnetic (magnetic flux) shielding.

The cover 4 is fastened to the base 3. Specifically, a flange 4a to be in surface contact with the base 3 is included on an end of the cover 4 on a base 3 side (Z2 side). The cover 4 is fixed to the base 3 by fastening the flange 4a to the base 3 by using screws 4b and the like. Also, the cover 4 has two cut-out parts 4c to expose the two connectors 8. Here, the flange 4a of the cover 4 is in contact with a surface 3a of the base 3 on the Z1 side. Also, gaskets for interrupting electromagnetic noise are arranged on boundaries between the connectors 8 and the cut-out parts 4c of the cover 4. The gaskets are formed of an electrically conductive material.

Also, the sensor apparatus 100 includes a pair of sensor sets 10. The sensor sets 10 include the gyroscopes 2, acceleration sensors 9, power supply circuits 5b, and the control boards 6 (control circuits 6b). The pair of sensor sets 10 have the same configuration as each other. The pair of sensor sets 10 are arranged side by side in a Y direction.

As shown in FIG. 2, the control board 6 includes X-axis control boards 6x, Y-axis control boards 6y, and Z-axis control boards 6z. Specifically, each of the pair of sensor sets 10 (see FIG. 1) includes a control board set including the X-axis control board 6x, the Y-axis control board 6y, and the Z-axis control board 6z. In each control board set, the X-axis control board 6x and the Y-axis control board 6y are connected to each other by the wiring part 6a, and the Z-axis control board 6z and the Y-axis control board 6y are connected to each other by the wiring part 6a.

A pair of X-axis control boards 6x are attached to the pair of X-axis surfaces 1x of the sensor mount 1. A pair of Y-axis control boards 6y are attached to the pair of Y-axis surfaces 1y of the sensor mount 1. The Z-axis control boards 6z in the pair of sensor sets 10 are attached to the Z-axis surface 1z on the Z1 side in the pair of Z-axis surfaces 1z of the sensor mount 1. The two Z-axis control boards 6z attached to the Z-axis surface 1z are arranged side-by-side in the Y direction.

The X-axis control board 6x for an X1 side is arranged in a Y1-side part of the X-axis surface 1x on the X1 side. The X-axis control board 6x for an X2 side is arranged in a Y2-side part of the X-axis surface 1x on the X2 side.

In addition, the control board 6 includes a microcontroller, a power supply, and the like (not shown). The control board 6 also includes an acceleration sensor 9. Here, in FIG. 2, each acceleration sensor 9 is schematically shown.

The power supply board 5 is arranged to cover the two Z-axis control boards 6z on the Z1 side. The power supply board 5 is connected to the control boards 6 (the pair of Y-axis control boards 6y) by wiring parts 5a. Specifically, the power supply board 5 includes power supply circuits 5b (see FIG. 5) for supplying power to the control circuits 6b (see FIG. 5) included in the control boards 6 through the wiring parts 5a. The power circuits 5b also supply power to the gyroscopes 2 and acceleration sensors 9. Each of the sensor sets 10 includes the power circuit 5b and the control circuit 6b. Also, each control circuit 6b receives information (detection values) from its corresponding gyroscopes 2, its corresponding acceleration sensor 9, and the like.

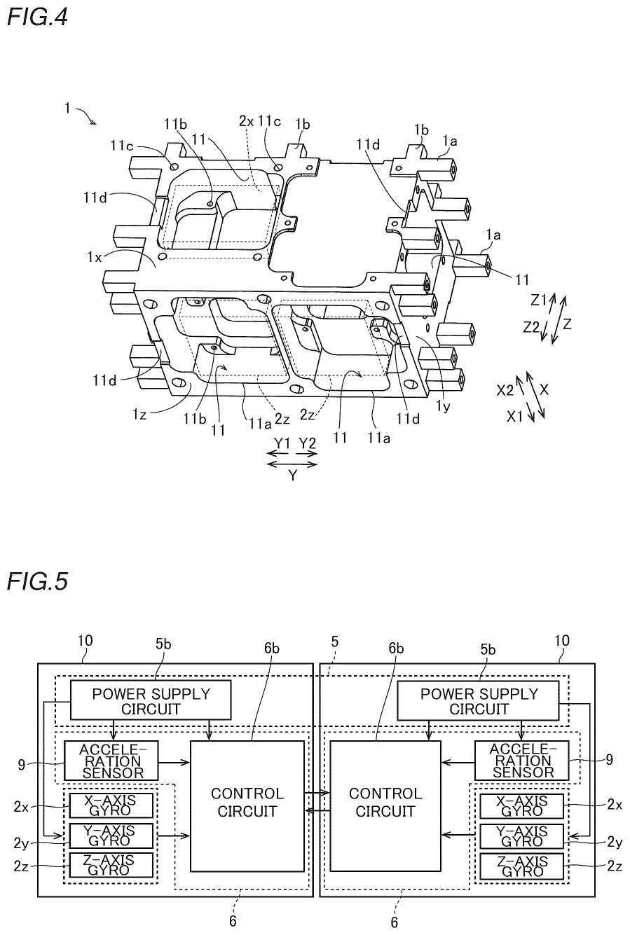

The plurality of gyroscopes 2 are arranged on the sensor mount 1 as shown in FIG. 3. The sensor mount 1 includes a plurality of recessed parts 11 which are opened in different directions from each other and each of which accommodates corresponding one of the plurality of gyroscopes 2. Specifically, the recessed parts 11 are arranged in the pair of X-axis surfaces 1x, the pair of Y-axis surfaces 1y, and the Z-axis surface 1z on the Z2 side of the sensor mount 1. Each of the pairs of X-axis surfaces 1x has one recessed part 11. Also, each of the pairs of Y-axis surfaces 1y has one recessed part 11. Also, the Z-axis surface 1z on the Z2 side has two recessed parts 11 as shown in FIG. 4. The two recessed parts 11 in the Z-axis surface 1z are arranged side by side in the Y direction (see FIG. 4).

Each of the plurality of gyroscopes 2 is accommodated in corresponding one of the recessed parts 11. Specifically, the gyroscope 2 is accommodated in the recessed part 11 not to protrude from an opened end 11a of the recessed part 11.

Also, the gyroscope 2 is fixedly arranged in the recessed part 11 by screwing screws 2a provided in four corners of the gyroscope 2 to screw insertion holes 11b arranged in the recessed part 11.

The gyroscopes 2 include a plurality of gyroscopes 2 for detecting a common type of physical quantities acting in two or more directions different from each other. All of the gyroscopes 2 that are arranged in the plurality of recessed parts 11 of the sensor arrangement part 1 and measure the common type of physical quantities are identical to each other in design. Specifically, the gyroscopes 2 include X-axis gyroscopes 2x, Y-axis gyroscopes 2y and Z-axis gyroscopes 2z corresponding to X, Y and Z axes, which are perpendicular to each other. The gyroscopes include two X-axis gyroscopes 2x, two Y-axis gyroscopes 2y and two Z-axis gyroscopes 2z. That is, the gyroscopes include a plurality of (specifically, a pair of) sensor sets 10 each of which includes the X-axis gyroscope 2x, the Y-axis gyroscope 2y and the Z-axis gyroscope 2z. Here, one of the pair of sensor sets 10 is provided as a backup (redundant) set of sensors for another sensor set 10.

Also, the X-axis gyroscopes 2x are examples of a “first-axis sensor” in the claims. Also, the Y-axis gyroscopes 2y are examples of a “second-axis sensor” in the claims. Also, the Z-axis gyroscopes 2z are examples of a “third-axis sensor” in the claims.

Also, the pair of sensor sets 10 are arranged on the common sensor mount 1. That is, the sensor apparatus 100 includes the single sensor mount 1 on which the pair of sensor sets 10 are commonly arranged.

Here, in this embodiment, the pair of X-axis gyroscopes 2x are arranged rotational symmetric to each other with respect to an axis line x that passes through a center of gravity of the sensor mount 1 and extends in the Z axis; the pair of Y-axis gyroscopes 2y are arranged rotational symmetric to each other with respect to the axis line x; and the pair of Z-axis gyroscopes 2z are arranged rotational symmetric to each other with respect to the axis line α. As a result, absolute values of detection values of each pair of sensors in the sensor sets 10 become the same as each other. For this reason, it is not necessary to provide an interface board for performing calculation based on the detection values of each pair of sensors in the sensor sets 10. Here, the sensor mount 1 has a rotational symmetric shape, which is rotational symmetric with respect to the axis line x. Note that “rotational symmetric” refers to a broad sense that includes not only perfect rotational symmetry but also rotational symmetry with small errors that bring the absolute values of the detection values of each pair of sensors in the sensor sets 10 in the same range. In other words, the pair of X-axis gyroscopes 2x, the pair of Y-axis gyroscopes 2y or the pair of Z-axis gyroscopes 2z may be arranged rotational asymmetric with respect to the axis line α in the sensor mount 1, which has the rotational symmetric shape with respect to the axis line x, as long as the rotational asymmetry affects the detection values of each pair of sensors in the sensor sets 10.

In detailed description, the pair of X-axis gyroscopes 2x are arranged at the same height position as each other in the Z direction. Also, the pair of X-axis gyroscopes 2x are offset from each other in the Y direction. Specifically, the X-axis gyroscope 2x on the X1 side is arranged in the recessed part 11 that is located in the Y2-side part of the X-axis surface 1x on the X1 side. Also, X-axis gyroscope 2x on the X2 side is arranged in the recessed part 11 that is located in the Y1-side part of the X-axis surface 1x on the X2 side.

Also, the pair of Y-axis gyroscopes 2y are arranged at the same height position as each other in the Z direction. Also, the pair of Y-axis gyroscopes 2y are offset from each other in the X direction. Specifically, the Y-axis gyroscope 2y on the Y1 side is arranged in the recessed part 11 that is located in the X1-side part of the Y-axis surface 1y on the Y1 side. The Y-axis gyroscope 2y on the Y2 side is arranged in the recessed part 11 that is located in the X2-side part of the Y-axis surface 1y on the Y2 side.

Also, the pair of Z-axis gyroscopes 2z are arranged at the same height position as each other in the Z direction. Also, the pair of Z-axis gyroscopes 2z are offset from each other in the X direction. The Z-axis gyroscope 2z on the Y1 side is arranged in the recessed part 11 that is located closer to the X1 side in the Z-axis surface 1z on the Z2 side. The Z-axis gyroscope 2z on the Y2 side is arranged in the recessed part 11 that is located closer to the X2 side in the Z-axis surface 1z on the Z2 side.

Also, in this embodiment, two or more of the plurality of recessed parts 11 of the sensor mount 1 in which the X-axis gyroscopes 2x have a common shape. Two or more of the plurality of recessed parts 11 in which the Y-axis gyroscopes 2y have a common shape. Two or more of the plurality of recessed parts 11 in which the Z-axis gyroscopes 2z have a common shape.

Here, since the pair of sensor sets 10 are arranged symmetric (rotational symmetric) to each other with respect to an axis, polarity of the detection values of each pair of sensors in the sensor sets 10 are opposite to each other. The control boards 6 (control circuits 6b) adjust the detection values of each pair of sensors in the sensor sets 10 to their positive or negative values. Also, since the pair of sensor sets 10 are arranged symmetric (rotational symmetric) to each other with respect to the axis, the pair of control boards 6 can have a common configuration. In other words, the pair of control boards have the common configuration in terms that each of the pair of control boards 6 includes the X-axis control board 6x, the Y-axis control board 6y, and the Z-axis control board 6z.

Also, in this embodiment, the pair of X-axis gyroscopes 2x are arranged in the recessed parts 11 in the pair of X-axis surfaces 1x, which are arranged on sides opposite to each other. Also, the pair of Y-axis gyroscopes 2y are arranged in the recessed parts 11 in the pair of Y-axis surfaces 1y, which are arranged on sides opposite to each other. That is, the gyroscopes 2 (2x, 2y) are arranged on their corresponding one of four side surfaces (1x, 1y) of the sensor mount 1.

The Z-axis gyroscopes 2z are arranged in their corresponding one of the two recessed parts 11 in the Z-axis surface 1z on the Z2 side. Here, no recessed part 11 is arranged on the Z-axis surface 1z on the Z1 side.

Here, in this embodiment, the plates 7 are arranged between the recessed parts 11 and the cover 4, and are arranged to cover the recessed parts 11 so as not to expose the gyroscopes 2 arranged in the recessed parts 11 of the sensor mount 1. Specifically, the plates 7 are arranged to overlap the entire recessed parts 11. Also, each plate 7 is fixed to the sensor mount 1 by inserting screws 7a arranged in four corners of the plate 7 into screw insertion holes 11c arranged outside corresponding one of recessed parts 11.

Also, the plates 7 provide electromagnetic noise shielding. Specifically, the plates 7 are formed of metal. In detailed description, the plates 7 are formed of a non-magnetic metal (e.g., aluminum alloy).

Also, in this embodiment, each plate 7 has a plate-like shape extending in corresponding one of the pair of X-axis surfaces 1x or corresponding one of the pair of Y-axis surfaces 1y of the sensor mount 1. Specifically, each plate 7 is formed in a square shape. The plate 7 is attached to the Y2-side part of the X-axis surface 1x on the X1 side, which is formed in a rectangular shape. Also, the plate 7 is attached to the Y1-side part of the X-axis surface 1x on the X2 side, which is formed in a rectangular shape.

Also, in this embodiment, the plates 7 include the X-axis plates 7x covering the recessed parts 11 arranged in the X-axis surfaces 1x, and the Y-axis plates 7y covering the recessed parts 11 arranged in the Y-axis surfaces 1y. The X-axis plates 7x are arranged side by side adjacent to the X-axis control boards 6x in the Y direction without overlapping the X-axis control boards 6x (see FIG. 1). The Y-axis plates 7y are arranged to overlap the Y-axis control boards 6y (see FIGS. 1 and 2). Here, the X-axis plates 7x and the Y-axis plates 7y are examples of the “shielding lid” in the claims, respectively.

Each Y-axis plate 7y has a plurality of cut-out parts 7b avoiding the Y-axis protrusions 1a of the sensor mount 1. Each X-axis plate 7x has no cut-out part.

In this embodiment, the base 3 is fixed to the sensor mount 1, and is arranged to close the opening 4d of the cover 4 and to cover at least one of the recessed parts 11 so as to shield against electromagnetic noise. Specifically, the base 3 (see FIG. 1) is arranged to cover the recessed parts 11 (see FIG. 4) arranged in the Z-axis surface 1z of the sensor mount 1 on the Z2 side. The base 3 is arranged to cover the entire surface of the Z-axis surface 1z on the Z2 side. That is, the two recessed parts 11 in which the two Z-axis gyroscopes 2z are arranged are covered by the common (single) base 3 in the Z-axis surface 1z.

In this embodiment, a projected area of the base 3 as viewed in a direction (Z direction) perpendicular to surfaces of the base 3 and the shielding cover 4 that face each other is larger than an opening area of the opening 4d of the cover 4. That is, the entire area of the opening 4d of the cover 4 is covered by the base 3.

Also, the base 3 provides electromagnetic noise shielding. Specifically, the base 3 is formed of metal. In detailed description, the base 3 is formed of a non-magnetic metal (e.g., aluminum alloy). That is, the cover 4, the plates 7, the sensor mount 1, and the base 3 are formed of the same material.

Also, in this embodiment, a thickness t1 of the base 3 (see FIG. 1) is greater than a thickness t2 of the cover 4 (see FIG. 1). Specifically, the thickness t1 of the base 3 is not smaller than twice (e.g., triple) the thickness t2 of the cover 4.

Also, the thickness t1 of the base 3 (see FIG. 1) is greater than a thickness t3 of the plate 7 (see FIG. 3). Specifically, the thickness t1 of the base 3 is not smaller than twice (e.g., triple) a thickness t3 of the plate 7. Here, no plate for shielding against electromagnetic noise is arranged between the base 3 and the Z-axis gyroscopes 2z. In other words, the base 3 and each Z-axis gyroscope 2z are arranged to face each other without the plate between them. The Z-axis gyroscope 2z is enclosed between each recessed part 11 and the base 3 to shield the Z-axis gyroscope 2z against electromagnetic noise.

Also, at least one gyroscope 2 (specifically, all of the X-axis gyroscopes 2x, the Y-axis gyroscopes 2y and the Z-axis gyroscopes 2z) includes a sensor main body 2b, and a connection wiring part 2c connecting the sensor main body 2b to the control board 6 (the Y-axis control board 6y). The gyroscopes 2 and the control board 6 (Y-axis control board 6y) that are included in the sensor set 10 common to each other are connected by the connection wiring parts 2c.

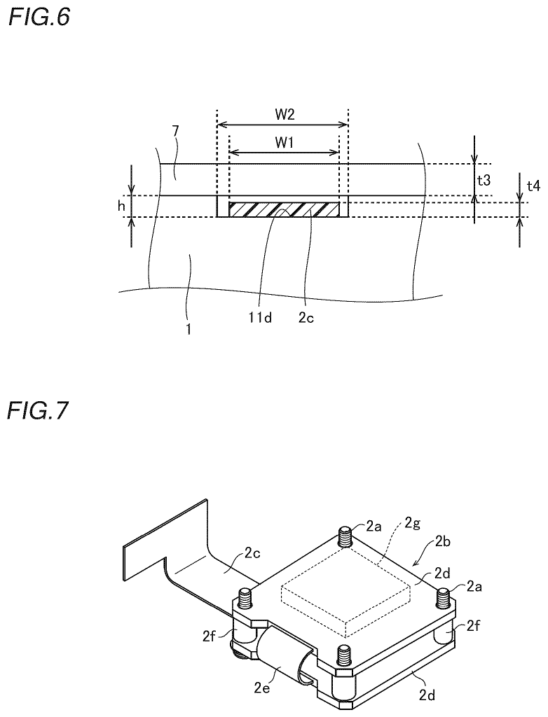

Here in this embodiment, at least one recessed part 11 (specifically, all of the recessed parts 11) of the sensor mount 1 includes a cut-out part 11d through which the connection wiring part 2c is drawn out. The cut-out parts 11d are arranged in the opened ends 11a of the recessed parts 11. In other words, the connection wiring parts 2c are drawn out through the cut-out parts 11d with recessed part 11 being covered by the plates 7 (base 3) (see FIG. 6). Here, the cut-out parts 11d are examples of a “second opening” in the claims. Here, the cut-out parts 11d may be arranged in the plates 7 or in both the recessed parts 11 and the plates 7.

As shown in FIG. 6, the connection wiring parts 2c have the thickness t3 (e.g., 0.8 mm). The cut-out parts 11d have a depth h (e.g., 1 mm) greater than the thickness t3. Also, the connection wiring parts 2c have a width W1. Also, the cut-out parts 11d have a width W2 greater than the width W1. Here, the plurality of cut-out parts 11d have the same size as each other.

Also, in this embodiment, the connection wiring parts 2c of the gyroscope 2 include flexible cables. In other words, the connection wiring parts 2c have flexibility (softness). The connection wiring parts 2c are formed of polyimide, for example. The connection wiring parts 2c include flexible cables so that the flexible cables can absorb shock even if vibration occurs. As a result, it is possible to prevent disconnection of the connection wiring parts 2c from the control boards 6. Also, since the connection wiring parts 2c include flexible cables, it is possible to bend the connection wiring parts 2c at an angle that can easily draw out the connection wiring parts in the recessed parts 11 through the cut-out parts 11d. Accordingly, even if a clearance between the cut-out part 11d and the connection wiring part 2c is reduced, it is possible to easily draw out the connection wiring part 2c through the cut-out part 11d. Since the aforementioned clearance can be reduced, it is possible to increase a frequency range of electromagnetic noise shielding provided by the plates 7 and the base 3 to a wider range (increase an upper limit on a high frequency side).

The connection wiring parts 2c, which extend from the X-axis gyroscope 2x, the Y-axis gyroscope 2y and the Z-axis gyroscopes 2z in each of the pair of sensor sets 10, are connected to the Y-axis control boards 6y with being bent (deformed).

Also, the gyroscope 2 includes a rigid flexible substrate, as shown in FIG. 7. The rigid flexible board refers to a board including rigid and flexible parts. The sensor main body 2b includes two rigid parts 2d, and a flexible part 2e connecting the rigid parts 2d to each other.

The two rigid parts 2d are arranged to face each other by bending the flexible part 2e. Here, the connection wiring part 2c extends from one of the two rigid parts 2d. Also, the flexible part 2e is formed of the same material (i.e., polyimide) as the connection wiring part 2c.

Also, the sensor main body 2b includes spacers 2f arranged between a pair of rigid parts 2d arranged to face each other. Predetermined space is formed between the two rigid parts 2d by the spacer 2f. The spacers 2f are arranged in four corners of each rectangular (square) rigid part 2d. Also, the spacers 2f have a cylindrical shape. The screws 2a are arranged to pass through the spacers 2f having the cylindrical shape. Dotted lines in FIG. 7 represent a sensor head 2g. The sensor head 2g is an electromagnetic type sensor head using MEMS technology, for example.

### Advantages of the Embodiment

In this embodiment, the following advantages are obtained.

In this embodiment, as described above, the sensor apparatus 100 is configured including the plates 7 for shielding against electromagnetic noise, which are arranged between the recessed parts 11 and the cover 4, and are arranged to cover the recessed parts 11 so as not to expose the gyroscopes 2 arranged in the recessed parts 11 of the sensor mount 1. Accordingly, the plates 7 can provide electromagnetic noise shielding even if electromagnetic noise enters an interior of the shielding cover 4. In other words, electromagnetic noise shielding can be duplicately provided by the cover 4 and the plates 7. As a result, even if a plurality of gyroscopes 2 are arranged in the cover 4, and the plurality of gyroscopes 2 are arranged in different positions and orientations in the sensor mount 1, an outer shield is formed by the cover 4 and the base 3, and inner shields are formed by the plates 7 and the recessed parts 11 of the sensor mount 1. Consequently, electromagnetic noise shielding is duplicately provided. Here, inner shields for the Z-axis gyroscopes 2z are formed by the recessed parts 11 of the sensor mount 1 and the base 3 by bringing the base 3 and the sensor mount 1 into tight contact with each other. In particular, in a case in which the recessed parts 11 are formed by cutting-out machining, the gyroscopes will be covered by the recessed parts 11 without any gaps except opened sides of the recessed parts 11 for the gyroscopes 2. As these results, it is possible to reduce difference of influence of noise between the plurality of gyroscopes 2 in a case in which the plurality of gyroscopes 2 for detecting the same type of physical quantities are arranged in positions and orientations different from each other.

Also, since the sensor head 2g is an electromagnetic type sensor head using MEMS technology, the sensor head 2g includes a magnet. For this reason, an advantage of reduction of difference of influence of noise between the plurality of gyroscopes 2 in a case in which the plurality of gyroscopes 2 for detecting the same type of physical quantities are arranged in positions and orientations different from each other is particularly effective for the electromagnetic type sensor head 2g using MEMS technology. Also, even in a case in which the sensor head 2g is a piezoelectric or electrostatic type sensor head, which does not include the magnet, since very small signals are processed, the advantage of reduction of difference of influence of noise between the plurality of gyroscopes 2 can be obtained similar to the electromagnetic type sensor head 2g.

In this embodiment, as described above, the sensor apparatus 100 is configured including the recessed parts 11 of the sensor mount 1 having cut-out parts 11d through which the connection wiring parts 2c are drawn out. Accordingly, even in a case in which the recessed parts 11 are covered by the plates 7, the connection wiring parts 2c can be easily drawn out from the recessed parts 11 through the cut-out parts 11d.

In this embodiment, as described above, the sensor apparatus 100 is configured including the connection wiring parts 2c of the gyroscope 2 having flexible cables. Accordingly, since the connection wiring parts 2c can be drawn out from the recessed parts 11 while being bent, it is possible to easily draw the connection wiring parts 2c out of the recessed part 11.

In this embodiment, as described above, the sensor apparatus 100 is configured including the base 3, which is fixed to the sensor mount 1, and is arranged to close the opening 4d of the cover 4 and to cover the recessed parts 11 that are arranged in the Z-axis surface 1z so as to shield against electromagnetic noise. Accordingly, since the base 3, which is fixed to the sensor mount 1, also serves as a part for shielding the Z-axis gyroscope 2z, it is possible to prevent a configuration of the sensor apparatus 100 from becoming complicated while reducing the number of parts.

In this embodiment, as described above, a projected area of the base 3 as viewed in a direction (Z direction) perpendicular to surfaces of the base 3 and the shielding cover 4 that face each other is larger than an opening area of the opening 4d of the cover 4. Accordingly, since the opening 4d of the cover 4 is entirely covered by the base 3, it is possible to effectively reduce electromagnetic noise entering the shielding cover 4.

In this embodiment, as described above, all of the gyroscopes 2 that are arranged in the plurality of recessed parts 11 of the sensor arrangement part 1 and measure the common type of physical quantities are identical to each other in design. Accordingly, since correction control of the sensor apparatus 100 for correcting difference between the gyroscopes 2 due to difference of designs can be eliminated, such elimination together with advantages of the present invention including reduction of influences of electromagnetic noise from the outside of the sensor apparatus 100 and reduction of evenness of noise entering the gyroscopes 2 allows easy correction control of the sensor apparatus 100.

In this embodiment, as described above, the sensor mount 1 includes X-axis surfaces 1x that extend perpendicular to the X axis and include the recessed parts 11 in which the X-axis gyroscopes 2x are arranged; Y-axis surfaces 1y that extend perpendicular to the Y axis and include the recessed parts 11 in which the Y-axis gyroscopes 2y are arranged; and a Z-axis surface 1z that extends perpendicular to the Z axis and includes the recessed parts 11 in which the Z-axis gyroscopes 2z are arranged. Accordingly, it is possible to reduce difference of influence of noise between the X-axis gyroscopes 2x, the Y-axis gyroscopes 2y, and the Z-axis gyroscopes 2z. In this embodiment, as described above, a plurality of sensor sets 10 are provided. Accordingly, even in a case in which the plurality of sensor sets 10 are provided, it is possible to reduce difference of influence of noise between the X-axis gyroscopes 2x, the Y-axis gyroscopes 2y, and the Z-axis gyroscopes 2z.

In this embodiment, as described above, two or more of the plurality of recessed parts 11 of the sensor mount 1 in which the X-axis gyroscopes 2x have a common shape. Two or more of the plurality of recessed parts 11 in which the Y-axis gyroscopes 2y have a common shape. Two or more of the plurality of recessed parts 11 in which the Z-axis gyroscopes 2z have a common shape. Accordingly, since two or more of the plurality of recessed parts 11 have the common shape, it is possible to simplify production of the sensor arrangement part 1 as compared with a case in which the two or more of the plurality of recessed parts 11 have shapes different from each other. Also, the two or more of the plurality of recessed parts 11 for the pair of X-axis gyroscopes 2x (pair of Y-axis gyroscopes 2y, pair of Z-axis gyroscopes 2z) have the common shape, distances between interior surfaces of the recessed parts 11 and exterior surfaces of the gyroscopes 2 can be the same in the pair of X-axis gyroscopes 2x (pair of Y-axis gyroscopes 2y, pair of Z-axis gyroscopes 2z), and as a result, it is possible to reduce noise influence difference between the pair of X-axis gyroscopes 2x (between the pair of Y-axis gyroscopes 2y, between the pair of Z-axis gyroscopes 2z).

In this embodiment, as described above, the sensor mount 1 has a rectangular parallelepiped shape. Accordingly, it is possible to easily arrange the X-axis gyroscopes 2x, the Y-axis gyroscopes 2y and the Z-axis gyroscopes 2z to correspond to the X axis, the Y axis and the Z axis, respectively, which are perpendicular to each other.

In this embodiment, as described above, the sensor apparatus 100 is configured including the gyroscopes 2. Here, the gyroscopes 2 process very small signals, and are susceptible to electromagnetic noise. For this reason, electromagnetic noise shielding provided by the plates 7 is particularly effective at properly operating the gyroscopes 2.

In this embodiment, as described above, the sensor apparatus 100 is configured including the plates 7, which include the X-axis plates 7x covering the recessed parts 11 arranged in the X-axis surfaces 1x, and the Y-axis plates 7y covering the recessed parts 11 arranged in the Y-axis surfaces 1y. Accordingly, since the X-axis plates 7x and the Y-axis plates 7y provide electromagnetic noise shielding even if electromagnetic noise enters an interior of the shielding cover 4, it is possible to further prevent anomalies caused by electromagnetic noise in the X-axis gyroscopes 2x and the Y-axis gyroscopes 2y.

In this embodiment, as described above, the sensor apparatus 100 is configured including a plurality of recessed parts 11 in which a plurality of Z-axis gyroscopes 2z are arranged are covered by the common base 3 in the Z-axis surface 1z. Consequently, it is possible to reduce the number of parts as compared with a case in which the plurality of recessed parts 11 in which the plurality of Z-axis gyroscopes 2z are arranged are covered by parts different from each other.

In this embodiment, as described above, the sensor apparatus 100 is configured including the pair of X-axis gyroscopes 2x being arranged in the recessed parts 11 in the pair of X-axis surfaces 1x, which are arranged on sides opposite to each other, and the pair of Y-axis gyroscopes 2y being arranged in the recessed parts 11 in the pair of Y-axis surfaces 1y, which are arranged on sides opposite to each other. Accordingly, it is possible to easily reduce an area of the X-axis surface 1x (Y-axis surface 1y) as compared with a case in which the X-axis gyroscopes 2x are arranged in a common X-axis surface 1x (the Y-axis gyroscopes 2y are arranged in a common Y-axis surface 1y). Consequently, it is possible to easily reduce size of the sensor mount 1 (sensor apparatus 100).

In this embodiment, as described above, the sensor apparatus 100 is configured including two sensor sets 10, which are arranged symmetric to each other with respect to an axis line a that passes through a center of gravity of the sensor mount 1 and extends in the Z axis. Accordingly, since absolute values of detection values of the pair of sensor sets 10 can be the same, even if an abnormality occurs in one of the pair of sensor sets 10, detection values of another of the pair of sensor sets 10 can be used.

### MODIFIED EMBODIMENTS

Note that the embodiment disclosed this time must be considered as illustrative in all points and not restrictive. The scope of the present invention is not shown by the above description of the embodiments but by the scope of claims for patent, and all modifications (modified embodiments) within the meaning and scope equivalent to the scope of claims for patent are further included.

Although it has been illustratively described in the aforementioned embodiment that each of the cover 4, the sensor mount 1, and the base 3 is formed as a unitary part each of the cover 4, the sensor mount 1, and the base 3 may include a plurality of parts. However, in a case in which the sensor sets 10 are used as a “pair” of sensor sets, the sensor mount 1 is preferably integrally formed as a unitary part in terms of positioning the pair of X-axis gyroscopes 2x (pair of Y-axis gyroscopes 2y, pair of Z-axis gyroscopes 2z) in the sensor sets 10.

Also, although it has been illustratively described in the aforementioned embodiment that the cover 4, the sensor mount 1, and the base 3 are separate parts, two or more of these parts may be integrally formed as a unitary part. Also, although the sensor apparatus 100 includes the cover 4, the sensor mount 1, and the base 3 as separate parts from the viewpoint of manufacturing and assembling the sensor apparatus, the sensor apparatus 100 may include other functional separate parts from another viewpoint other than manufacturing and assembling the sensor apparatus.

For example, the example in which the gyroscope 2 (sensor) is arranged in the recessed part 11 of the sensor mount 1 (sensor arrangement part) has been shown in the aforementioned embodiment, the present invention is not limited to this. For example, a sensor (e.g., an acceleration sensor 9 or a temperature sensor) other than the gyroscope 2 may be arranged in the recessed part 11. Also, a plurality of types of sensors may be arranged in the recessed parts 11. Also, the recessed parts 11 that accommodate the same type of sensors arranged in proximity to each other may have a structure communicating with each other.

While the example in which the connection wiring part 2c of the gyroscope 2 (sensor) is drawn out through the cut-out part 11d (opening) of the recessed part 11 has been shown in the aforementioned embodiment, the present invention is not limited to this. For example, the connection wiring part 2c may be drawn out through a hole arranged in proximity to the opened end 11a of the recessed part 11.

While the example in which the connection wiring part 2c includes a flexible cable has been shown in the aforementioned embodiment, the present invention is not limited to this. For example, the connection wiring part 2c may be a cable without flexibility (softness) (e.g., busbar).

While the example in which each of the sensor mount 1 (sensor arrangement part), plates 7 (shielding lids), and the base 3 is formed of metal has been shown in the aforementioned embodiment, the present invention is not limited to this. For example, any of the sensor mount 1, the plates 7 and the base 3 may be formed of non-magnetic ceramics or a non-magnetic resin. From the viewpoint of heat dissipation, the sensor mount 1, the plates 7, and the base 3 are preferably formed of metal.

While the example in which the gyroscopes 2 (sensors) corresponding to the X axis (first axis), the Y axis (second axis), and the Z axis (third axis) are separately provided has been shown in the aforementioned embodiment, the present invention is not limited to this. A single gyroscope corresponding to all of the X, Y and Z axes may be provided.

While the example in which no plate for shielding against electromagnetic noise is arranged between the base 3 and the Z-axis gyroscopes 2z (third-axis sensor) has been shown in the aforementioned embodiment, the present invention is not limited to this. A plate for shielding against electromagnetic noise may be arranged between the base 3 and the Z-axis gyroscopes 2z (third-axis sensor). In this case, the base 3, the plate that is arranged between the base 3 and the Z-axis gyroscopes 2z are an example of the “shielding cover” and an example of the “shielding lid”, respectively, in the claims.

While the example in which a thickness t1 of the base 3 is greater than a thickness t2 of the cover 4 (shielding cover) has been shown in the aforementioned embodiment, the present invention is not limited to this. The thickness t1 of the base 3 may be not greater than the thickness t2 of the cover 4.

While the example in which the base 3 is directly attached to the opening 4d of the cover 4 has been shown in the aforementioned embodiment, the present invention is not limited to this. Another part may be arranged over a part of or the entire of the opening 4d of the cover 4, and the base 3 may be attached to the opening 4d of the cover 4 through the another part. Also, airtightness between the cover 4 and the base 3 is not required.

While the example in which the sensor mount 1 (sensor arrangement part) has a rectangular parallelepiped shape has been shown in the aforementioned embodiment, the present invention is not limited to this. The sensor mount 1 may have a shape (e.g., cubic shape) other than the rectangular parallelepiped shape.

While the example in which the sensor apparatus 100 includes two sensor sets 10 each of which includes a set of the X-axis gyroscope 2x (first-axis sensor), the Y-axis gyroscope 2y (second-axis sensor) and the Z-axis gyroscope 2z (third-axis sensor) has been shown in the aforementioned embodiment, the present invention is not limited to this. The sensor apparatus 100 may include only one aforementioned sensor set 10. For example, the sensor apparatus 100 may include three or more aforementioned sensor sets 10.

While the example in which a pair of Z-axis gyroscope 2z (third-axis sensors) are arranged in a common Z-axis surface 1z (third surface) of the sensor mount 1 (sensor arrangement part) has been shown in the aforementioned embodiment, the present invention is not limited to this. The pair of Z-axis gyroscopes 2z may be arranged in the Z-axis surfaces 1z, which are arranged on sides opposite to each other. Also, a pair of X-axis gyroscopes 2x (first-axis sensors) may be arranged in a common X-axis surface 1x (first surface). Also, a pair of Y-axis gyroscopes 2y (second-axis sensors) are arranged in a common Y-axis surface 1y (second surface).

While the example in which a pair of sensor sets 10 are arranged symmetric with respect to an axis line x that extends in the Z axis (third axis) has been shown in the aforementioned embodiment, the present invention is not limited to this. Two sensor sets 10 may be arranged rotational symmetric with respect to an axis line x that passes through a center of gravity of the sensor mount 1 (sensor arrangement part) and extends in the X axis (first axis) or the Y axis (second axis). The pair of sensor sets 10 may be arranged origin symmetric with respect to an origin of the sensor mount 1. Pairs of sensors in the sensor sets 10 may be arranged side by side in the X direction, the Y direction, and the Z direction.

While the example in which the common cover 4, the common sensor mount 1, and the common base 3 are commonly provided to a plurality of sensor sets or a pair of sensor sets 10 has been shown in the aforementioned embodiment, the present invention is not limited to this. Any one or more of the cover 4, the sensor mount 1, and the base 3 may be separately provided to their corresponding sensor sets 10. For example, the base 3 may be commonly provided to a plurality of sensor sets 10, and the sensor mounts 1 and the covers 4 may be separately provided to their corresponding sensor sets 10.

While the example in which the recessed parts 11 of the sensor mount 1 include cut-out parts 11d through which the connection wiring parts 2c are drawn out has been shown in the aforementioned embodiment, the present invention is not limited to this. Instead of the cut-out parts 11d of the recessed parts 11, at least one plate 7 may include an opening (cut-out part) through which the connection wiring part 2c is drawn out. Also, in addition to the cut-out parts 11d of the recessed parts 11, at least one plate 7 may include an opening (cut-out part) through which the connection wiring part 2c is drawn out.

### DESCRIPTION OF REFERENCE NUMERALS

1; sensor mount (sensor arrangement part)

1x; X-axis surface (first surface) (surface)

1y; Y-axis surface (second surface) (surface)

1z; Z-axis surface (third surface)

2; gyroscope (sensor)

2b; sensor main body

2c; connection wiring part

2x; X-axis gyroscope (first-axis sensor)

2y; Y-axis gyroscope (second-axis sensor)

2z; Z-axis gyroscope (third-axis sensor)

3; base

4; cover (shielding cover)

4d; opening (first opening)

6; control board (controller)

7; plate (shielding lid)

7x; X-axis plate (shielding lid)

7y; Y-axis plate (shielding lid)

10; sensor set

11; recessed part

11d; cut-out part (second opening)

100; sensor apparatus

t1; thickness (thickness of base)

t2; thickness (thickness of cover)

X; axis (first axis)

Y; axis (second axis)

Z; axis (third axis)

α; axis line

1. A sensor apparatus comprising:
a plurality of sensors for detecting a common type of physical quantities acting in two or more directions different from each other;
a sensor arrangement part including a plurality of recessed parts that are opened in different directions from each other and in which the plurality of sensors are arranged;
a shielding cover for shielding against electromagnetic noise, the shielding cover being arranged to cover the sensor arrangement part and provided with at least one first opening; and
shielding lids for shielding against the electromagnetic noise, the shielding lids being arranged between the plurality of recessed parts and the shielding cover and covering the plurality of recessed parts to prevent exposure of the plurality of sensors that are arranged in the plurality of recessed parts.

2. The sensor apparatus according to claim 1 further comprising a controller for receiving information from the plurality of sensors, wherein
at least one of the plurality of sensors includes a sensor main body, and a connection wiring part between the sensor main body and the controller, and
at least one of the plurality of recessed parts of the sensor arrangement part and/or at least one of the shielding lids includes a second opening through which the connection wiring part is drawn out.

3. The sensor apparatus according to claim 2, wherein the connection wiring part of the sensor includes a flexible cable.

4. The sensor apparatus according to claim 1 further comprising a base for shielding against the electromagnetic noise, the base being fixed to the sensor arrangement part and arranged to close the first opening of the shielding cover and to cover at least one of the plurality of recessed parts.

5. The sensor apparatus according to claim 4, wherein a projected area of the base as viewed in a direction perpendicular to surfaces of the base and the shielding cover that face each other is larger than an opening area of the first opening of the shielding cover.

6. The sensor apparatus according to claim 1, wherein all of the plurality of sensors that are arranged in the plurality of recessed parts of the sensor arrangement part and measure the common type of physical quantities are identical to each other in design.

7. The sensor apparatus according to claim 6, wherein the plurality of sensors include one sensor set of a first-axis sensor, a second-axis sensor and a third-axis sensor corresponding a first axis, a second axis and a third axis perpendicular to each other or a plurality of sensor sets of first-axis sensors, second-axis sensors and third-axis sensors corresponding the first axis, the second axis and the third axis perpendicular to each other; and
the sensor arrangement part includes a first surface that extends perpendicular to the first axis and includes the recessed part in which the first axis sensor is arranged, a second surface that extends perpendicular to the second axis and includes the recessed part in which the second axis sensor is arranged, and a third surface that extends perpendicular to the third axis and includes the recessed part in which the third axis sensor is arranged.

8. The sensor apparatus according to claim 7, wherein the plurality of sensors include the plurality of sensor sets of the first-axis sensors, the second-axis sensors and the third-axis sensors.

9. The sensor apparatus according to claim 8, wherein two or more of the plurality of recessed parts of the sensor arrangement part in which the first axis sensors are arranged have a common shape; two or more of the plurality of recessed parts of the sensor arrangement part in which the second axis sensors are arranged have a common shape; and two or more of the plurality of recessed parts of the sensor arrangement part in which the third axis sensors are arranged have a common shape.

10. The sensor apparatus according to claim 9, wherein the sensor arrangement part has a rectangular parallelepiped shape.

11. The sensor apparatus according to claim 10, wherein each of the first axis sensor, the second axis sensor and the third axis sensor included in each sensor set includes a gyroscope.
